(19) United States
(12) Patent Application Publication
(10) Pub. No.: US 2010/0311501 A1
(43) Pub. Date: Dec. 9, 2010

(54) Game controller

(76) Inventor: Kent T. J. Hsu, Taipei (TW)

Correspondence Address: SAM CHEN, 7F-1, 293, ROOSEVELT ROAD, SEC 3, TAIPEI, TW

(21) Appl. No.: 12/478,760

(22) Filed: Jun. 4, 2009

(51) Int. Cl. A63F 13/00; A63F 9/24

(52) U.S. Cl. 463/30; 463/37

(57) ABSTRACT

A game controller includes a game controller chip; function keys electrically connected to the game controller chip; a joystick electrically connected to the game controller chip; an LCD display controlled by the game controller chip via a graph controller chip; a camera controlled by the game controller chip via a digital video converter; a microphone controlled by the game controller chip via a digital sound converter; an amplifier controlled by the digital sound converter; a sound device controlled by the digital sound converter via the amplifier; a touch panel, a temperature and motion sensor, a transmission interface, a wireless network module, an MPEG encoder and decoder, a memory device, and an IR transceiver electrically connected to the game controller chip respectively; and a rechargeable battery for powering the game controller chip.

### BACKGROUND OF THE INVENTION

1. Field of Invention

The invention relates to game controllers for controlling a video game and more particularly to such a game controller with improved characteristics.

2. Description of Related Art

Conventionally, a video game console or personal computer is equipped with a game controller for playing. But this is unsatisfactory for the purpose for which the invention is concerned for the following reasons: Only basic functions are provided by the game controller. No interaction between a user and the console is available. Moreover, a user cannot see real time information from the console. Thus, the need for improvement still exists.

### SUMMARY OF THE INVENTION

It is therefore one object of the invention to provide a game controller comprising a game controller chip; a plurality of function keys electrically connected to the game controller chip; a joystick electrically connected to the game controller chip; an LCD (liquid crystal display) display controlled by the game controller chip via a graph controller chip; a camera controlled by the game controller chip via a digital video converter; a microphone controlled by the game controller chip via a digital sound converter; an amplifier controlled by the digital sound converter; a sound device controlled by the digital sound converter via the amplifier; a touch panel, a temperature and motion sensor, a transmission interface, a wireless network module, an MPEG (Motion Picture Experts Group) encoder and decoder, a memory device, and an IR (infrared) transceiver electrically connected to the game controller chip respectively; and a rechargeable battery for powering the game controller chip.

The above and other objects, features and advantages of the invention will become apparent from the following detailed description taken with the accompanying drawings.

### BRIEF DESCRIPTION OF THE DRAWINGS

FIG. 1 is an electronic block diagram of game controller according to the invention;

FIG. 2 is a perspective view of a first preferred embodiment of game controller according to the invention; and

FIG. 3 is a perspective view of a second preferred embodiment of game controller according to the invention.

### DETAILED DESCRIPTION OF THE INVENTION

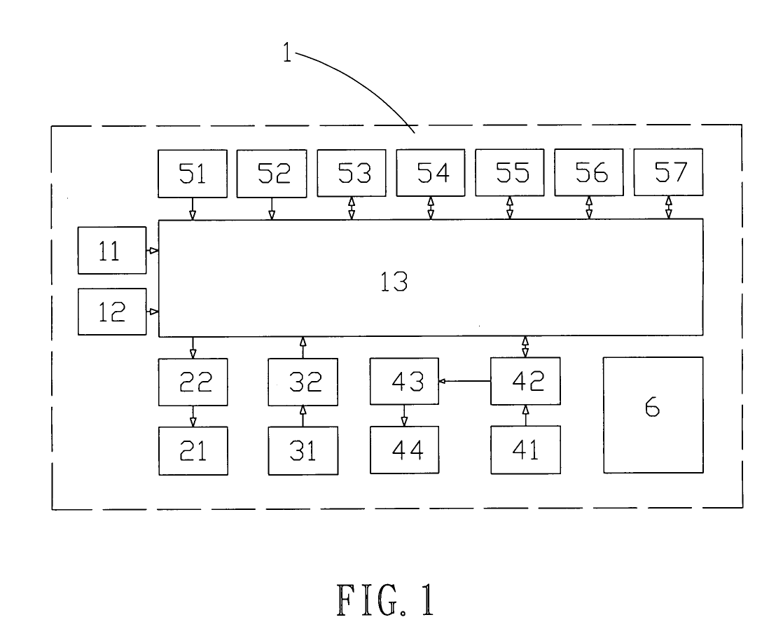

Referring to FIGS. 1 to 3, a game controller 1 in accordance with the invention comprises the following components as discussed in detail below.

A plurality of function keys 11 and a joystick 12 are electrically connected to a game controller chip 13. The game controller chip 13 may control an LCD (liquid crystal display) display 21 via a graph controller chip 22. The game controller chip 13 may control a camera 31 via a digital video converter 32. A digital sound converter 42 is electrically interconnected the game controller chip 13 and a microphone 41. The digital sound converter 42 may send an audio signal to a sound device 44 via an amplifier 43.

A touch panel 51, a temperature and motion sensor 52, a transmission interface 53, a wireless network module 54, an MPEG (Motion Picture Experts Group) encoder and decoder 55, a memory device 56, and an IR (infrared) transceiver 57 are electrically connected to the game controller chip 13 respectively. Moreover, the game controller 1 is powered by a rechargeable battery 6 which is charged by an external charger (not shown).

The game controller chip 13 is implemented as a single chip and functions as a master processor for running game programs, data input or output, and communicating with a video game console (not shown).

The touch panel 51 is for converting a touch signal into a coordinate signal to be processed by the game controller chip 13. The touch panel 51 may simulate a function key or mouse operation.

A user may press a function key 11 to perform a specific function or may manipulate the joystick 12 to point in one of different directions.

The temperature and motion sensor 52 is used to sense room temperature and sense a motion of the game controller 1. The transmission interface 53 can be implemented for wire or wireless operation and is used to communicate with the video game console.

The wireless network module 54 is used to connect the game controller 1 to the Internet.

The MPEG encoder and decoder 55 is used to encode compressed audio and video data in the form of MPEG and decode same.

The memory device 56 is used to store data and game programs and can be a semiconductor memory element or an external memory device.

The amplifier 43 is used to increase the strength of an electrical sound signal.

The sound device 44 is implemented as a speaker for converting electric current to sound waves and for amplifying this sound to a desired volume.

The digital sound converter 42 is used to convert digital sound into encoded sound signals and decode same.

The microphone 41 is used to convert the mechanical energy of sound waves into an electric signal.

The camera 31 is used to transform image into electrical signals.

The digital video converter 32 is used to convert the electrical signals into digital video signals.

The graph controller chip 22 is used to control graphs shown on the LCD display 21.

The LCD display 21 is either a black and white one or a color one.

The IR transceiver 57 is used to receive and transmit IR signals.

The rechargeable battery 6 is used to power the game controller 1.

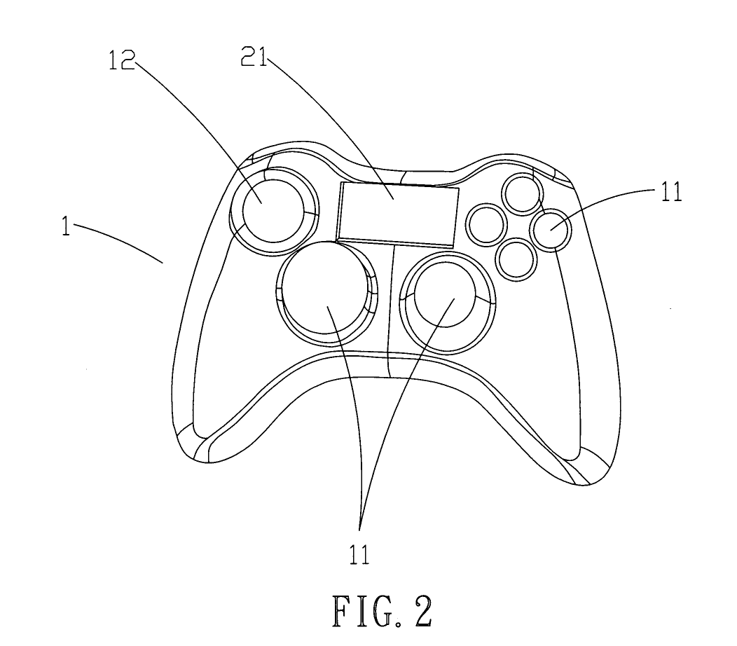

As shown in FIG. 2 specifically, the game controller 1 is shaped as a typical Xbox 360 Wireless controller in a first preferred embodiment of the invention.

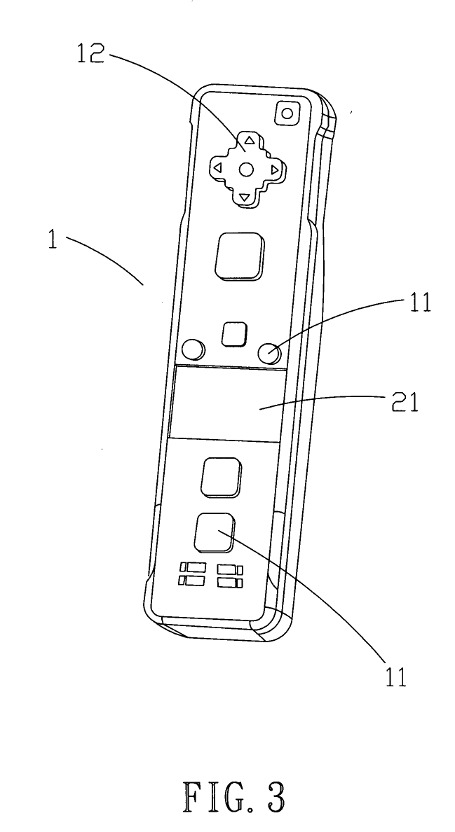

As shown in FIG. 3 specifically, the game controller 1 is shaped as a typical Wii Remote in a second preferred embodiment of the invention.

The game controller 1 can provide the following functions:

Video games which are stored in the memory device 56 or an external memory device. A user may play a video game by himself of herself. Alternatively, users can play against each other.

Picture in picture so that a user may train himself or herself when an online game is being played.

Local time, date, and calender.

Timer and alarm. Room temperature display.

Amount of the remaining electric current of the rechargeable battery 6.

Personal data includes name, sex, age, height, weight, etc.

Calorie consumption of a user playing games. This function is performed by using the temperature and motion sensor 52.

Digital photographs which are stored in the memory device 56 or an external memory device.

Digital camera which is effected by using the camera 31.

Indoor cordless telephone or walkie-talkie which is effected by cooperating with a cordless telephone exchange.

Wireless online and Internet telephony which are effected by using the wireless network module 54.

Audio and video clips which are stored in the memory device 56 or an external memory device.

E-book and e-dictionary which are stored in the memory device 56 or an external memory device.

Remote controller which is effected by using the IR transceiver 57.

Three-dimensional coordinate which is effected by using the temperature and motion sensor 52.

While the invention herein disclosed has been described by means of specific embodiments, numerous modifications and variations could be made thereto by those skilled in the art without departing from the scope and spirit of the invention set forth in the claims.

What is claimed is:

1. A game controller comprising:
a game controller chip (13);
a plurality of function keys (11) electrically connected to the game controller chip (13);
a joystick (12) electrically connected to the game controller chip (13);
an LCD (liquid crystal display) display (21) controlled by the game controller chip (13) via a graph controller chip (22);
a camera (31) controlled by the game controller chip (13) via a digital video converter (32);
a microphone (41) controlled by the game controller chip (13) via a digital sound converter (42);
an amplifier (43) controlled by the digital sound converter (42);
a sound device (44) controlled by the digital sound converter (42) via the amplifier (43);
a touch panel (51), a temperature and motion sensor (52), a transmission interface (53), a wireless network module (54), an MPEG (Motion Picture Experts Group) encoder and decoder (55), a memory device (56), and an IR (infrared) transceiver (57) electrically connected to the game controller chip (13) respectively; and
a rechargeable battery (6) for powering the game controller chip (13).

2. The game controller of claim 1, wherein the sound device (44) is a loudspeaker.

3. The game controller of claim 1, wherein the LCD display (21) is a black and white display.

4. The game controller of claim 1, wherein the LCD display (21) is a color display.
